(19) United States
(12) Patent Application Publication
(10) Pub. No.: US 2026/0368304 A1
(43) Pub. Date: Nov. 19, 2026

(54) Orchestrated Account Creation on a Cloud Computing Platform

(71) Applicant: DISH Wireless L.L.C., Littleton, CO (US)

(72) Inventors: Devin Drawhorn, Spring, TX (US); Steven Wilson, Aurora, CO (US)

(21) Appl. No.: 19/207,901

(22) Filed: May 14, 2025

(51) Int. Cl. G06F 21/45

(52) U.S. Cl. CPC G06F 21/45

(57) ABSTRACT

Various arrangements for performing account creation on a cloud computing platform are detailed herein. The method can include defining, via a user interface provided by a cloud service in a subordinate cloud computing account on the cloud computing platform, a request for creation of a plurality of subordinate cloud computing accounts on the cloud computing platform. The method can include accessing, by the cloud service in the subordinate cloud computing account, a root cloud computing account using access credentials, wherein each of the plurality of subordinate cloud computing accounts are to be subordinate to the root cloud computing account. The method can include initiating, by the cloud service in the subordinate cloud computing account, a function in the root cloud computing account that manages creation of the plurality of subordinate cloud computing accounts.

### BACKGROUND

In a cloud computing environment, large organizations (e.g., companies) may need to create a significant number of subordinate cloud accounts. Such accounts have restricted access, such as to only a small number of cloud resources of the organization, for security reasons. Creating a subordinate cloud account can be a time-intensive process, requiring many minutes before the next subordinate cloud computing account can be created. Conventionally, this process is performed by a user that logs into a root cloud account, begins the process of creating a first subordinate account, then, after a time, logs back in to create a second subordinate account once the first subordinate account has been created. If a large number of subordinate accounts are to be created, the user may need to devote a significant amount of time to performing these aspects of account creation.

### SUMMARY

A method for performing account creation on a cloud computing platform can include defining, via a user interface provided by a cloud service in a subordinate cloud computing account on the cloud computing platform, a request for creation of a plurality of subordinate cloud computing accounts on the cloud computing platform. The cloud service in the subordinate cloud computing account may access a root cloud computing account using access credentials. Each of the plurality of subordinate cloud computing accounts can be subordinate to the root cloud computing account. The cloud service in the subordinate cloud computing account may initiate a function in the root cloud computing account. The function can manage the creation of the plurality of subordinate cloud computing accounts.

Embodiments of such a method can include one or more of the following features. Each of these features can be independently incorporated as part of an embodiment of a method. The function in the root cloud computing account may initiate the creation of a first subordinate cloud computing account. The creation can occur as part of the plurality of cloud computing accounts defined in the request. The root cloud computing account may monitor an account generation service of the cloud computing platform. The monitoring can be performed using an event rule defined within the root cloud computing account. The event rule may detect an event indicative of the first subordinate cloud computing account having been created. In response to detecting the event indicative of the first subordinate cloud computing account having been created, the function may initiate the creation of a second subordinate cloud computing account. The second subordinate cloud computing account can be part of the plurality of cloud computing accounts defined in the request. In response to detecting the event indicative of the first subordinate cloud computing account having been created, the function may cause a notification to be transmitted. The notification can be sent to a user mapped to the request. The cloud service in the subordinate cloud computing account may receive access credentials from a user. The access credentials to the subordinate cloud computing account can differ from the access credentials for the root cloud computing account. Based on the request for creation of the plurality of subordinate cloud computing accounts, the database stored in the subordinate cloud computing account may be modified. The modification can indicate each of the plurality of subordinate cloud computing accounts defined in the request. Based on the request for creation of the plurality of subordinate cloud computing accounts, a name of each subordinate cloud computing account may be validated. The validation can occur as part of the account creation process. Each of the plurality of subordinate cloud computing accounts may be used to provide access to a cloud resource. The cloud resource can be one of a plurality of cloud resources supported by a corresponding vendor. The plurality of cloud resources may comprise cellular network functions (NFs).

A system for performing account creation on a cloud computing platform can include a subordinate cloud computing account implemented on the cloud computing platform. A cloud service used for initiating account generation may be executed within the subordinate cloud computing account. The system can also include a root cloud computing account implemented on the cloud computing platform. An orchestration function may be executed within the root cloud computing account. Via a user interface provided through the subordinate cloud computing account on the cloud computing platform, a request for creation of a plurality of subordinate cloud computing accounts may be submitted to the cloud service executed in the subordinate cloud computing account. The cloud service in the subordinate cloud computing account can access a root cloud computing account using access credentials. Each of the plurality of subordinate cloud computing accounts may be subordinate to the root cloud computing account. The cloud service in the subordinate cloud computing account can initiate an orchestration function in the root cloud computing account. The orchestration function may manage the creation of the plurality of subordinate cloud computing accounts.

Embodiments of such a system can include one or more of the following features. Each of these features can be independently incorporated as part of an embodiment of a system. The system may further comprise the cloud computing platform. The orchestration function may be configured to initiate the creation of a first subordinate cloud computing account. The first subordinate cloud computing account can be part of the plurality of subordinate cloud computing accounts. The system may further comprise an event rule executed within the root cloud computing account. The event rule can be configured to monitor an account generation service of the cloud computing platform. The event rule may detect an event indicative of the first subordinate cloud computing account having been created. The event rule may be further configured to trigger the function in response to detecting the event indicative of the first subordinate cloud computing account having been created. The function can initiate the creation of a second subordinate cloud computing account of the plurality of subordinate cloud computing accounts defined in the request. The orchestration function may be further configured to cause a notification to be transmitted in response to detecting the event indicative of the first subordinate cloud computing account having been created. The notification can be sent to a user mapped to the request. The cloud service may be further configured to receive access credentials to the subordinate cloud computing account. The access credentials to the subordinate cloud computing account can differ from the access credentials for the root cloud computing account. The cloud service may be further configured to modify a database stored in the subordinate cloud computing account. The modification can be based on the request for creation of the plurality of subordinate cloud computing accounts on the cloud computing platform. The database may indicate each of the plurality of subordinate cloud computing accounts defined in the request.

The cloud service may be further configured to validate a name of each of the plurality of subordinate cloud computing accounts. The validation can be based on the request for creation of the plurality of subordinate cloud computing accounts on the cloud computing platform.

In some embodiments, a non-transitory processor-readable medium is presented that can include processor-readable instructions. The processor-readable instructions may be configured to cause one or more processors to define, in a subordinate cloud computing account on the cloud computing platform, a request for creation of a plurality of subordinate cloud computing accounts on the cloud computing platform. The processor-readable instructions can cause one or more processors to access, in the subordinate cloud computing account, a root cloud computing account using access credentials. Each of the plurality of subordinate cloud computing accounts may be subordinate to the root cloud computing account. The processor-readable instructions can cause one or more processors to initiate a function in the root cloud computing account. The function may manage the creation of the plurality of subordinate cloud computing accounts.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label, irrespective of the second reference label.

FIG. 1 illustrates an embodiment of a cellular network system, according to certain embodiments.

FIG. 2 illustrates an exemplary core, according to certain embodiments.

FIG. 3 illustrates an embodiment of a cellular network core network topology as implemented on a public cloud computing platform, according to certain embodiments.

FIG. 4 illustrates an embodiment of multiple subordinate accounts being used to manage cloud resources.

FIG. 5 illustrates an embodiment of a system that performs account creation for a cloud computing environment.

FIGS. 6A and 6B illustrate an embodiment of a method for performing account creation for a cloud computing environment.

### DETAILED DESCRIPTION

In a cloud computing environment, an organization, such as a large corporate enterprise, may desire that many subordinate cloud computing accounts exist that have restricted access to only certain defined cloud resources of the organization. As an example, a cellular network that has its core components executed in the cloud can involve a high number of cloud resources being executed. It may be desirable to have separate accounts that have access to different cloud resources. For example, a vendor that supports a particular cloud resource can be provided a subordinate account that allows for access to only the vendor's supported cloud resources being used as part of the cellular network. The vendor is therefore restricted from modifying or otherwise interacting with other cloud resources that are not supported by the vendor.

Creation of subordinate cloud computing accounts can involve accessing a master root cloud computing account. For example, via Amazon Web Services (AWS), a user may use access credentials to access a root cloud computing account and use Control Tower to generate subordinate cloud computing accounts sequentially. Whether on AWS or another cloud computing platform, accessing a root cloud computing account is highly sensitive from a security standpoint: through maliciousness or incompetence, the root cloud computing account can be used to make highly significant changes to all cloud resources in the account hierarchy of the root cloud computing account, including those mapped to subordinate cloud computing accounts associated with the root cloud computing account.

As detailed herein, rather than a user directly accessing a root cloud computing account to create subordinate cloud computing accounts, a subordinate cloud computing account can be created in which cloud computing resources are executed that use credentials to access the root cloud computing account for the purpose of orchestrating the creation of subordinate accounts.

A user can access a user interface provided via a defined subordinate cloud computing account (referred to herein as a “creator account”) and provide a listing of subordinate cloud computing accounts to be created via a user interface (UI). The user's active portion of subordinate account generation is thus complete-cloud computing resources in the creator account engage cloud services in the root account to create the one or more new subordinate cloud computing accounts requested by the user. The cloud computing platform may only permit a single subordinate cloud computing account to be created at a time, which may take at least several minutes. Cloud computing resources activated in the root account monitor for the creation of a subordinate account and trigger generation of a next-requested subordinate cloud computing account previously indicated by the user. This process repeats until all requested subordinate cloud computing accounts have been created.

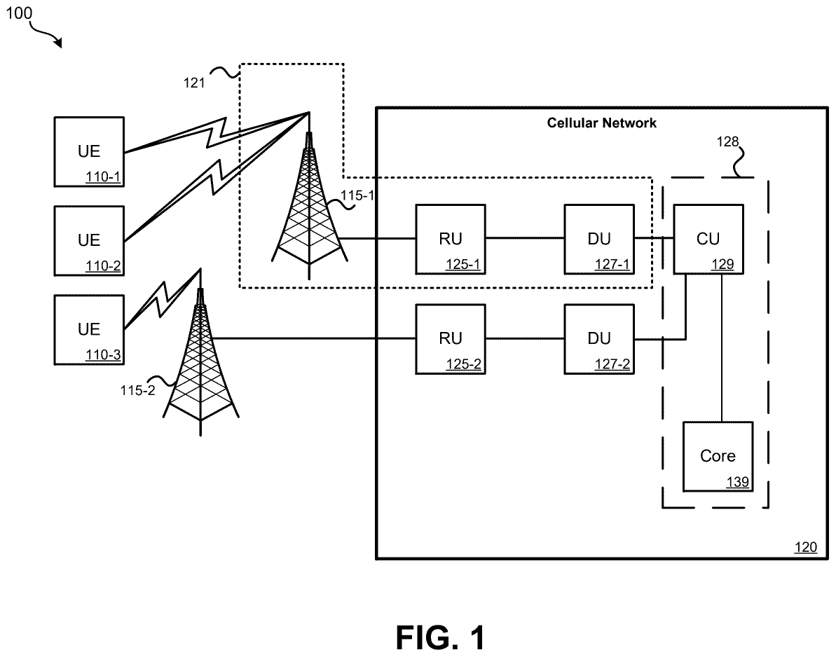

Further detail regarding such embodiments is provided in relation to the figures. While embodiments detailed are focused on a cloud implementation of a cellular network, alternative embodiments can be used for various other types of cloud resources that are to be distributed across multiple subordinate cloud computing accounts. FIG. 1 illustrates an embodiment of a cellular network, including radio access network (RAN) components, referred to as a cellular network system 100 (“system 100”). System 100 can include a fifth generation (5G) New Radio (NR) cellular network; other types of cellular networks, such as a fourth generation (4G) long-term evolution (LTE) cellular network, sixth generation (6G) cellular network, seventh generation (7G) cellular network, and beyond, are also possible to use in accordance with embodiments detailed herein. System 100 can include: UE 110 (UE 110-1, UE 110-2, UE 110-3); base station 115; cellular network 120; radio units 125 (“RUs 125”); distributed units 127 (“DUs 127”); central unit 129 (“CU 129”); and core 139.

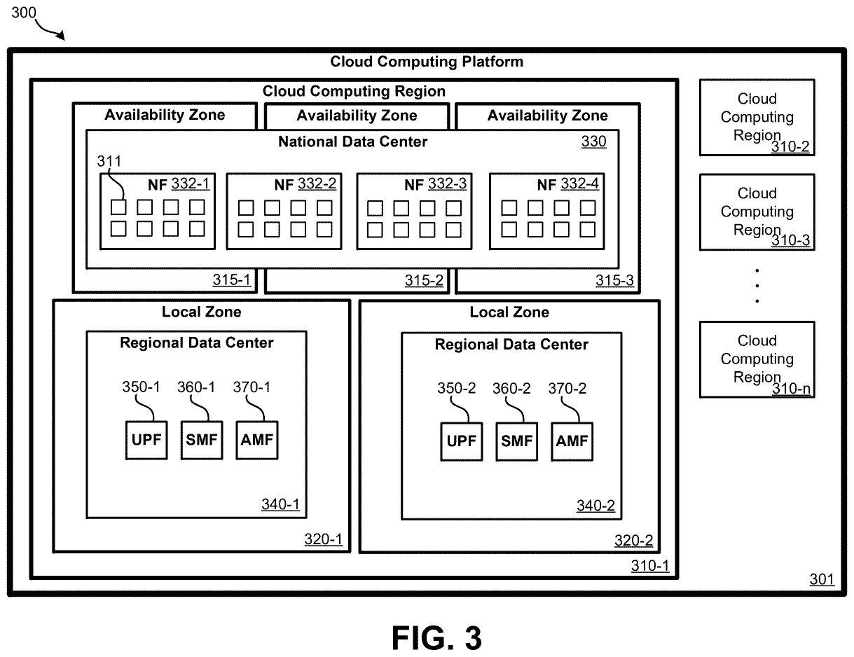

FIG. 1 represents a component-level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 3. As an example, a public cloud computing platform, such as Amazon Web Services (AWS), can be used to host cellular network functions in association with one or more accounts (e.g., a root account and some number of subordinate accounts) mapped to the cellular network provider. Other, unrelated cloud computing accounts are present on the cloud computing platform. Software can be executed and data stored by the public cloud computing platform, such that each account's processing and data is kept isolated from the processing and data in other accounts.

UEs 110 can represent various types of end-user devices, such as smartphones, cellular modems, cellular-enabled computerized devices, sensor devices, manufacturing equipment, gaming devices, access points (APs), any computerized device capable of communicating via a cellular network, etc. UEs can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UEs 110 use RF to communicate with RUs 125 of cellular network 120.

Two base stations 115 (BS 115-1, 115-2) are illustrated. Real-world implementations of system 100 can include many (e.g., hundreds, thousands) base stations, and many RUs, DUs, and CUs. BSs 115 can include one or more antennas that allow RUs 125 to communicate wirelessly with UEs 110. RUs 125 can represent an edge of cellular network 120 where data is transitioned to wireless communication and can be located at BSs 115. In some implementations, the radio access technology (RAT) used by RU 125 is 5G New Radio (NR). Other implementations use other RAT, such as 4G Long Term Evolution (LTE) or a later radio technology related to 6G or beyond. The remainder of cellular network 120 may be based on an exclusive 5G architecture, a hybrid 4G/5G architecture, a 4G architecture, or some other cellular network architecture (e.g., 6G or beyond).

Base station equipment 121 may include at least one RU, such as RU 125-1 and a DU (e.g., DU 127-1) located on site at the base station. In some embodiments, the DU may be physically remote from the RU. In some embodiments, multiple DUs are housed at a central location and connected to geographically distant (e.g., within a couple of kilometers) RUs.

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radio frequency band near 600 Megahertz allocated for cellular communications).

One or more DUs, such as DU 127-1, may communicate with CU 129. Collectively, RUs, DUs, and a CU create a gNodeB, which serves as a portion of the radio access network (RAN) of cellular network 120. CU 129 can communicate with cellular network core 139 (“core 139”). The specific architecture of cellular network 120 can vary by embodiment. Edge cloud server systems (not illustrated) outside of cellular network 120 may communicate, either directly, via the Internet, or via some other network, with components of cellular network 120. For example, one or more DUs 127-1 may be able to communicate with an edge cloud server system without routing data through CU 129 or core 139.

At a high level, the various components of a gNodeB can be understood as follows: RUs perform RF-based communication with UE; DUs support lower layers of the protocol stack such as the radio link control (RLC) layer, the medium access control (MAC) layer, and the physical communication layer; and CUs support higher layers of the protocol stack such as the service data adaptation protocol (SDAP) layer, the packet data convergence protocol (PDCP) layer, and the radio resource control (RRC) layer. A single CU can provide service to multiple co-located or geographically distributed DUs.

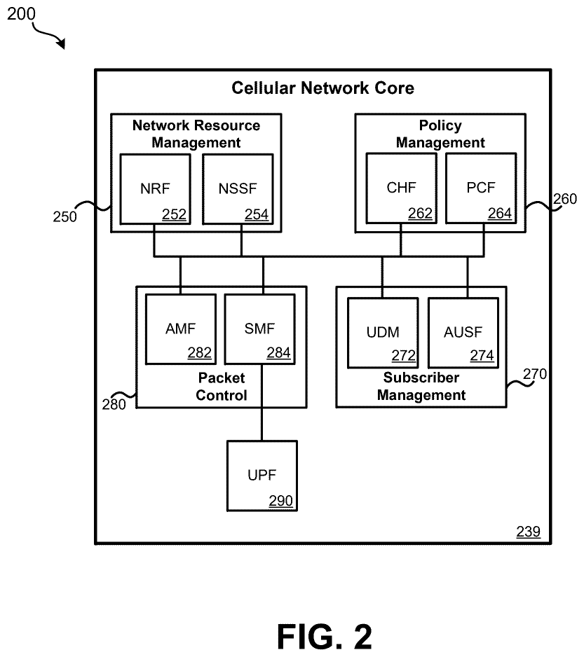

FIG. 2 illustrates core 239, according to certain embodiments. Core 239 can be physically distributed across data centers or located at a central national data center (NDC), such as detailed in relation to FIG. 3, can perform various core functions of the cellular network. Core 239 can include: network resource management components 250; policy management components 260; subscriber management components 270; and packet control components 280. Individual components may communicate via a bus, thus allowing various components of core 239 to communicate with each other directly. Core 239 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 210 of FIG. 2).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection- and session-related information from UEs and is responsible for handling connection and mobility management tasks. SMF 284 is responsible for interacting with the decoupled data plane, creating, updating, and removing Protocol Data Unit (PDU) sessions, and managing session context with the User Plane Function (UPF).

User plane function (UPF) 290 can be responsible for packet routing and forwarding, packet inspection, quality of service (QOS) handling, and external PDU sessions for interconnecting with a Data Network (DN) (e.g., the Internet).

While FIG. 1 illustrates various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In a virtualized arrangement, specialized software on general-purpose hardware may be used to perform the functions of components such as DU 127, CU 129, and core 139. Functionality of such components can be co-located or located at disparate physical server systems. For example, certain components of core 139 may be co-located with components of CU 129.

Returning to FIG. 1, some O-RAN implementations of CU 129 and/or core 139 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129 and core 139. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a public third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested. A “public” cloud-based computing platform refers to a platform where various unrelated entities can each establish one or more accounts and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1; a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QOS parameters and different network configurations.

As illustrated in FIG. 1, UE 110 may be operating on one or more production slices of cellular network 120. As detailed later in this document, a UE that functions on a particular entity's local network may be assigned to a slice particular to the entity or a slice that provides a particular QoE for tasks to be performed by the entity's UE.

Components such as DUs 127, CU 129, and core 139 may include various software components that are required to communicate with each other, handle large volumes of data traffic, and properly respond to changes in the network. In order to ensure not only the functionality and interoperability of such components, but also the ability to respond to changing network conditions and the ability to meet or perform above vendor specifications, significant testing must be performed.

FIG. 3 illustrates an embodiment of a cellular network core network topology 300 as implemented on a public cloud computing platform, according to certain embodiments. The cellular network core network topology 300 can be an implementation of core 139 of FIGS. 1 and 2. Cellular network core network topology 300 can represent how logical cellular network groups are distributed across cloud computing infrastructure of cloud computing platform 301. Cloud computing platform 301 can be logically and physically divided up into various different cloud computing regions 310. Each of cloud computing regions 310 can be isolated from other cloud computing regions to help provide fault tolerance, fail-over, load-balancing, and/or stability, and each of cloud computing regions 310 can be composed of multiple availability zones, each of which can be a separate data center located in general proximity to each other (e.g., within 600 miles). Further, each of cloud computing regions 310 may provide superior service to a particular geographic region based on physical proximity. For example, cloud computing region 310-1 may have its datacenters and hardware located in the northeast of the United States, while cloud computing region 310-2 may have its datacenters and hardware located in California. For simplicity, the details of the cellular network as executed in only cloud computing region 310-1 is illustrated. Similar components may be executed in other cloud computing regions of cloud computing regions 310 (310-2, 310-3, 310-n).

In other embodiments, cloud computing platform 301 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 310 may include multiple availability zones 315. Each of availability zones 315 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 315. For example, a database that is maintained as part of NDC 330 may be replicated across availability zones 315; therefore, if an availability zone of the cloud computing region is unavailable, a copy of the database remains up-to-date and available, thus allowing for continuous or near continuous functionality.

On a (e.g., public) cloud computing platform, especially public platforms, cloud computing region 310-1 may include the ability to use a different type of data center or group of data centers, which can be referred to as local zones 320. For instance, a client, such as a provider of the hybrid cloud cellular network, can select from more options of the computing resources that can be reserved at an availability zone 315 compared to a local zone 320. However, a local zone 320 may provide computing resources nearby geographic locations where an availability zone 315 is not available. Therefore, to provide low latency, certain network components, such as regional data centers 340, can be implemented at local zones 320 rather than availability zones 315. In some circumstances, a geographic region can have both a local zone 320 and an availability zone 315.

In the topology of a 5G NR cellular network, 5G core functions of core 139 can logically reside as part of a national data center (NDC) 330. NDC 330 can be understood as having its functionality existing in cloud computing region 310-1 across multiple availability zones 315. At NDC 330, various network functions, such as NFs 332, are executed. For illustrative purposes, each NF 332, whether at NDC 330 or elsewhere located, can be comprised of multiple sub-components, referred to as pods (e.g., pod 311) that are each executed as a separate process by the cloud computing region 310. The illustrated number of pods 311 is merely an example; fewer or greater numbers of pods 311 may be part of the respective 5G core functions. It should be understood that in a real-world implementation, a cellular network core, whether for 5G or some other standard, can include many more network functions. By distributing NFs 332 across availability zones 315, load-balancing, redundancy, and fail-over can be achieved. In local zones 320, multiple regional data centers 340 can be logically present. Each of regional data centers 340 may execute 5G core functions for a different geographic region or group of RAN components. As an example, 5G core components that can be executed within an RDC, such as RDC 340-1, may be: UPFs 350, SMFs 360, and AMFs 370. While instances of UPFs 350 and SMFs 360 may be executed in local zones 320, SMFs 360 may be executed across multiple local zones 320 for redundancy, processing load-balancing, and fail-over.

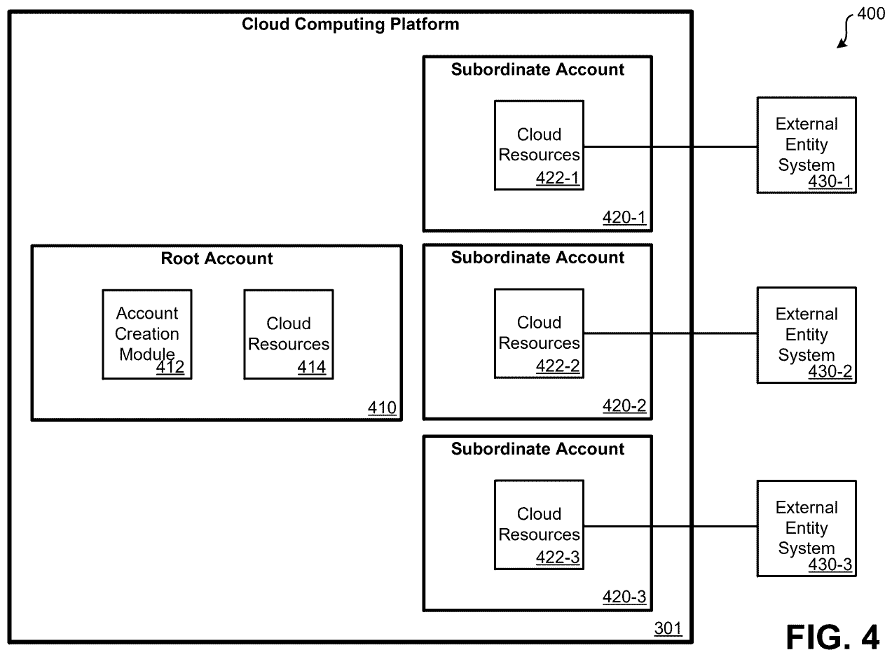

FIG. 4 illustrates an embodiment 400 of a cloud computing platform system 301 on which multiple subordinate accounts are being used to manage cloud resources. System 400 can be implemented on a cloud computing platform 301, which can be a public cloud computing platform, such as AWS. On cloud computing platform 301, a root account 410 may be established by a client (e.g., an organization, a company, or an entity). Root account 410 is a master account through which a high (e.g., the highest) level of administrator access is provided. By accessing root account 410, highly significant changes can be made to cloud resources executed within root account 410 and any subordinate accounts to root account 410. For example, through root account 410, access to cloud resources in subordinate accounts 420 may be possible. Further, through root account 410, any of subordinate accounts 420 may be deleted or have their access restricted. Through root account 410, a user may be able to delete any cloud resource present within root account 410 and subordinate accounts 420. Accordingly, access to root account 410 should only be granted to a minimal number of users that require such high-level access.

Subordinate accounts 420 are subordinate to a root account 410. While three subordinate accounts 420 are illustrated, this is by way of example only-fewer or greater numbers of subordinate accounts may be present in other embodiments. Through root account 410, the creation and deletion of subordinate accounts 420 is managed. Through root account 410, permissions may be managed that allow for cloud resources executed in a subordinate account of subordinate accounts 420 to communicate with cloud resources in the root account 410 and/or another subordinate account.

Access to a subordinate account allows an entity (e.g., an organization, a company, a user, a vendor) to access and manage only the cloud resources within the accessed subordinate account. For example, external entity system 430-1 can access subordinate account 420-1 and interact with cloud resources 422-1. External entity system 430-1 may be permitted to collect information and, possibly, modify cloud resources 422-1. External entity system 430-1, via its credentials to subordinate account 420, cannot access other subordinate accounts of subordinate accounts 420 or root account 410. As an example of how such an arrangement might be used, a cellular network provider may provide root account 410 access to a small number of high-level administrators. Individual vendors may be responsible for monitoring and maintaining certain cloud resources which they support, such as NFs. Via a subordinate account, a vendor may be provided access to manage (e.g., modify, delete, install, monitor) only cloud resources supported by that particular vendor. For example, a first vendor can use external entity system 430-1 to manage cloud resources 422-1; a second vendor may use external entity system 430-2 to manage cloud resources 422-2; and a third vendor may use external entity system 430-3 to manage cloud resources 422-3. Via root account 410, an administrator may be permitted to manage not only cloud resources 414 but also cloud resources 422.

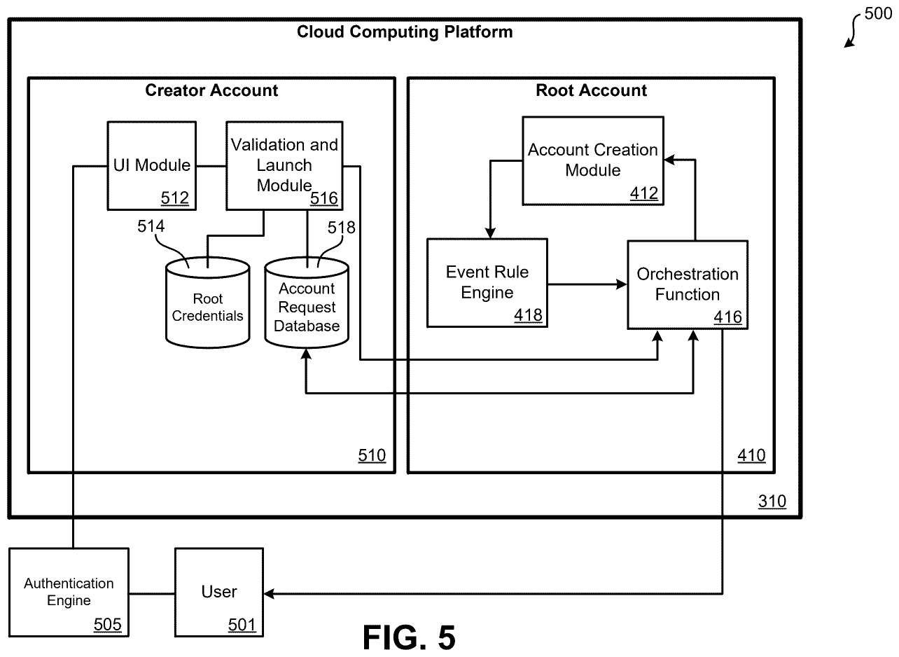

Via root account 410, account creation module 412, which represents a cloud-implemented resource, is used to create subordinate accounts, such as subordinate accounts 420. Account creation module 412 can be provided as part of cloud computing platform 301 to all clients that use that platform. Further detail regarding account creation module 412 is provided in relation to FIG. 5.

FIG. 5 illustrates an embodiment of a system 500 that performs account creation for a cloud computing environment. System 500 includes two accounts being implemented on cloud computing platform 310: root account 410 as detailed in relation to FIG. 4 and creator account 510. Creator account 510 is a subordinate account to root account 410 and was created via root account 410.

Within root account 410, account creation module 412, orchestration function 416, and event rule engine 418 may be available, with each being implemented as a cloud computing process. Account creation module 412, which represents a cloud-implemented resource, is used to create subordinate accounts, such as subordinate accounts 420. Account creation module 412 can be provided as part of cloud computing platform 301 to all clients that use that platform. As an example, on AWS, Control Tower can represent a resource that can be accessed via root account 410 and used to create, delete, and manage subordinate accounts. Account creation module 412 can be accessed to create a subordinate account that will be used as a creator account 510. Account creation module 412 may only be able to create subordinate accounts serially; that is, account creation module 412 cannot begin creation of a second subordinate account until creation of a first subordinate account is complete.

Within creator account 510, various resources may be present, including: UI module 512; root credentials 514; validation and launch module 516; and account request database 518, each implemented as a cloud computing process. Each of these resources can be executed directly within creator account 510 or executed in another account and accessed via creator account 510. Access to UI module 512 is managed by authentication engine 505. A user accessing UI module 512 may not have access to credentials that allow unfettered access to creator account 510. Upon successful authentication of access credentials submitted to authentication engine 505, the user can access and interact with UI module 512.

In UI module 512, the user can define one or more subordinate accounts that the user desires to be created. The user can provide a desired name for each account and, possibly, other characteristics, such as which cloud resources the subordinate account is to have access to. The user can specify the one or more account names direct to UI module 512 or can load a prepopulated file (e.g., a text file containing comma-separated values).

Once the user has provided indications of the subordinate accounts that are to be generated, the account names may be passed to validation and launch module 516. Validation and launch module 516 can analyze each account name and determine if each name is in accordance with the naming convention permitted by cloud computing platform 310. If not, an error may be returned to UI module 512, allowing the user to correct it. If the account names are acceptable, the account names can be loaded into account request database 518. Other fields may also be validated, including an email address tied to the account and an owner email address to which notifications are sent.

Validation and launch module 516 has access to root credentials 514. Root credentials 514 can be in the form of a key identifier and secret access key that allows validation and launch module 516 to access root account 410. This form of credentials can remain valid until explicitly deleted. Neither these root credentials 514 nor any other form of username or password for the root account are exposed to user 501; that is, while root credentials 514 are used by creator account 510, root credentials 514 are not accessible to user 501. For example, root credentials 514 may be coded directly into validation and launch module 516 or UI module 512. On AWS, root credentials can be referred to as an identity and access management (IAM) role that allows validation and launch module 516 to access AWS resources within the root account. A particular IAM role can be restricted such that it is only permitted to access particular resources within the root account, such as orchestration function 416.

Using root credentials 514, validation and launch module 516 can access root account 410 and provide orchestration function 416 with a first account name for a first subordinate account to be created. Orchestration function 416 can be a serverless function (i.e., cloud computing platform 310 allocates sufficient resources to allow execution of orchestration function 416). On AWS, such a function can be referred to as a lambda function. Orchestration function 416 is executed within root account 410. Orchestration function 416 accesses account creation module 412 and initiates the process for creation of a subordinate account having the first account name.

Creation of a subordinate account can take a significant amount of time, such as several minutes or even half an hour. In that time, orchestration function 416 can enter a sleep or suspended state. Event rule engine 418 can be active within root account 410 to watch for an event output by account creation module 412. In response to detecting a subordinate account having been created successfully by account creation module 412, event rule engine 418 causes orchestration function 416 to wake. Following the first subordinate account having been successfully created, a notification can be transmitted to user 501. This notification may be sent via email to an email address supplied by the user via UI module 512. Alternatively, the notification may be passed back to a module within creator account 510, then transmitted or made available to the user. Other forms of notification can be used, such as a graphical indication within UI module 512 or a text message.

In response to the first subordinate account having been successfully created, orchestration function 416 can query account request database 518 to determine a next account name for a subordinate account to be generated. Alternatively, all the requested account names may be loaded at one time to orchestration function 416. Using the second requested account name, orchestration function communicates with account creation module 412 to initiate creation of the second requested subordinate account.

This process repeats until all subordinate accounts requested by user 501 have been created. Throughout this process, user 501 never directly accesses root account 410. Rather, only a component of creator account 510 accesses root account 410. As such, there is less of a security concern for users accessing creator account 510, since the components within creator account 510 can only be used for creating additional subordinate accounts.

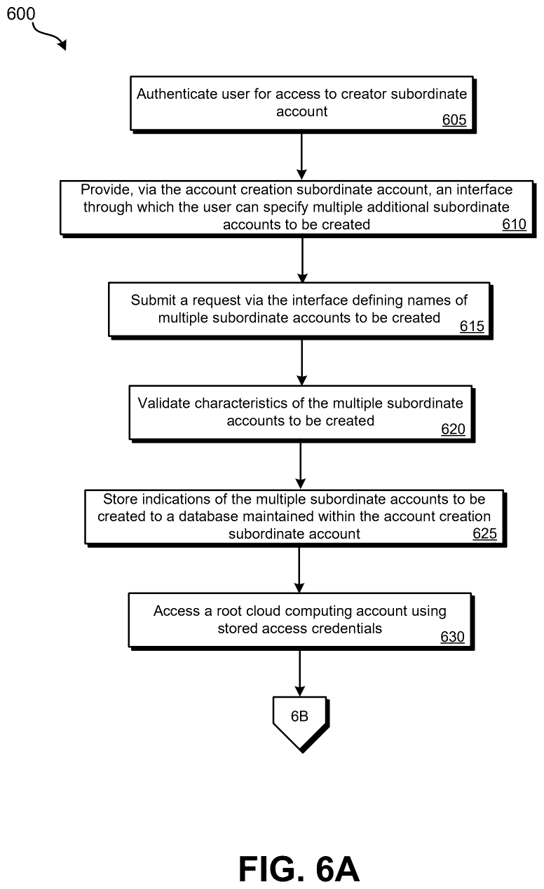

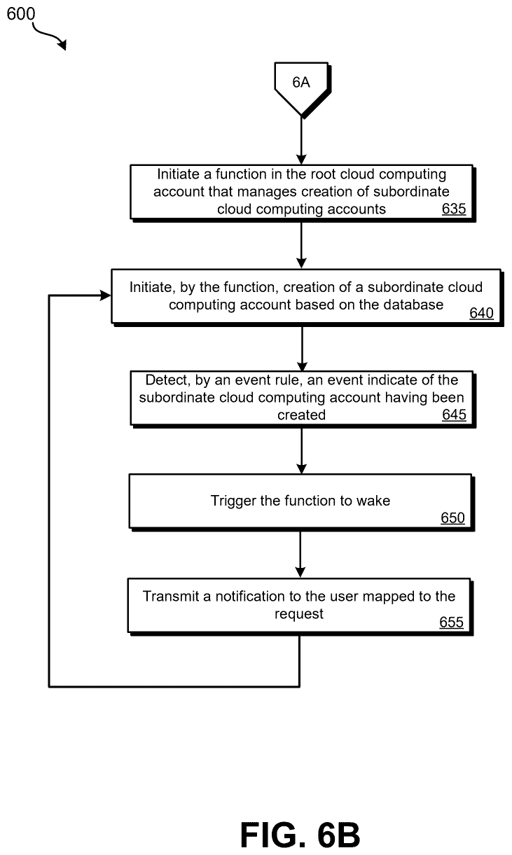

Various methods can be performed using the systems detailed in relation to FIGS. 1-5. FIG. 6 illustrates an embodiment of a method 600 for performing account creation for a cloud computing environment. Method 600 can begin at block 605, where a user is authenticated to access a UI interface hosted within a creator subordinate account. This subordinate account is associated with a root account. Authentication credentials supplied by the user do not permit access to the root account, but do permit access to the UI interface within creator subordinate account. The user having such limited credentials ensures the user possesses the necessary permissions to initiate subordinate account creation, but may not have access to perform any other functions within the root account or the creator subordinate account.

Once authenticated, at block 610, access to a user interface via the account creation subordinate account is provided. This interface allows the user to specify one or more additional subordinate accounts to be created. The user may provide an indication for a name for each subordinate account to be created. Additional fields may also be provided, such as allowing the user to specify other parameters for each account. The user may provide contact information, such as an email address or phone number, at which the user will later receive notifications regarding the subordinate account generation. The user may be permitted to upload a batch listing of names of subordinate account to be created. At block 615, the user may submit a request through the user interface after providing the names of the one or more subordinate accounts to be created. For example, to submit the request, the user may provide an approval to begin the account generation process. Once the request is submitted, assuming no errors, the user's needed interaction with the system is complete.

The system may then validate the characteristics of the subordinate accounts to be created at block 620. This validation can involve verifying that the user-provided account names are unique and comply with format requirements. Once validated, indications of the validated subordinate accounts may be stored in a database at block 625. This database can be maintained within the account creation subordinate account, within a separate subordinate account, or within the root account.

At block 630, the process may access a root cloud computing account using stored access credentials, such as a key and associated key identifier (e.g., associated with an IAM role on AWS). The access credentials are not directly accessible by the user. As such, the creation subaccount can only be leveraged to create new subordinate accounts, not make any other changes to the root account.

Moving to block 635 on FIG. 6B, a function within the root account on the cloud computing platform is activated to manage the creation of the subordinate cloud computing accounts in sequential order by leveraging the cloud platform provider's account creation module, such as AWS's Control Tower. The function, such as orchestration function 416, can interact directly with account creation module 412 to initiate creation of a first subordinate account using the name provided by the user at block 640. Following block 640, after a time, the function may suspend or go to sleep, such as due to the lengthy amount of time it takes for the account creation module to complete creation of a subordinate account.

After some amount of time elapsing (e.g., seconds, minutes, more than 30 minutes, etc.) an event rule established within the root account may detect an event indicating the creation of a subordinate cloud computing account at block 645. This detection can involve monitoring a log, such as AWS CloudTrail, for confirmation that the account creation process has been completed successfully for the first subordinate account.

Upon detecting the event at block 650, the event rule can trigger the function to wake or run again. At block 655, the function can transmit a notification to the user that submitted the request. This notification can inform the user of the successful creation of the first subordinate account and provide details or confirmations regarding the process completion. The notification may be provided to the email account or phone number previously provided by the user.

Following block 655, method 600 can return to block 640 to initiate creation of the next new subordinate account using the second name provided by the user. Blocks 640-655 then repeat for each new subordinate account requested by the user.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for performing account creation on a cloud computing platform, the method comprising:
defining, via a user interface provided by a cloud service in a subordinate cloud computing account on the cloud computing platform, a request for creation of a plurality of subordinate cloud computing accounts on the cloud computing platform;
accessing, by the cloud service in the subordinate cloud computing account, a root cloud computing account using access credentials, wherein each of the plurality of subordinate cloud computing accounts are to be subordinate to the root cloud computing account; and
initiating, by the cloud service in the subordinate cloud computing account, a function in the root cloud computing account that manages creation of the plurality of subordinate cloud computing accounts.

2. The method for performing account creation on a cloud computing platform of claim 1, further comprising:
initiating, by the function, creation of a first subordinate cloud computing account of the plurality of cloud computing accounts from the request.

3. The method for performing account creation on a cloud computing platform of claim 2, further comprising:
monitoring, using an event rule defined within the root cloud computing account, an account generation service of the cloud computing platform; and
detecting, by the event rule, an event indicative of the first subordinate cloud computing account having been created.

4. The method for performing account creation on a cloud computing platform of claim 3, further comprising:
in response to detecting the event indicative of the first subordinate cloud computing account having been created, initiating, by the function, creation of a second subordinate cloud computing account of the plurality of cloud computing accounts from the request.

5. The method for performing account creation on a cloud computing platform of claim 3, further comprising:
in response to detecting the event indicative of the first subordinate cloud computing account having been created, causing, by the function, a notification to be transmitted to a user mapped to the request.

6. The method for performing account creation on a cloud computing platform of claim 1, further comprising:
receiving, by the cloud service in the subordinate cloud computing account on the cloud computing platform from a user, access credentials to the subordinate cloud computing account, wherein the access credentials to the subordinate cloud computing account differ from access credentials for the root cloud computing account.

7. The method for performing account creation on a cloud computing platform of claim 1, further comprising:
based on the request for creation of the plurality of subordinate cloud computing accounts on the cloud computing platform, modifying a database stored in the subordinate cloud computing account to indicate each of the plurality of subordinate cloud computing accounts of the request.

8. The method for performing account creation on a cloud computing platform of claim 7, further comprising:
based on the request for creation of the plurality of subordinate cloud computing accounts on the cloud computing platform, validating a name of each of the plurality of subordinate cloud computing accounts of the request.

9. The method for performing account creation on a cloud computing platform of claim 1, wherein each of the plurality of subordinate cloud computing accounts is used to provide access to a cloud resource of a plurality of cloud resources supported by a corresponding vendor.

10. The method for performing account creation on a cloud computing platform of claim 9, wherein the plurality of cloud resources comprises cellular network functions (NFs).

11. A system for performing account creation on a cloud computing platform, the system comprising:
a subordinate cloud computing account implemented on a cloud computing platform wherein a cloud service used for initiating account generation is executed within the subordinate cloud computing account; and
a root cloud computing account implemented on the cloud computing platform, an orchestration function being executing within the root cloud computing account, wherein:
via a user interface provided via the subordinate cloud computing account on the cloud computing platform, a request for creation of a plurality of subordinate cloud computing accounts on the cloud computing platform is submitted to the cloud service executed in the subordinate cloud computing account;
the cloud service in the subordinate cloud computing account accesses a root cloud computing account using access credentials, wherein each of the plurality of subordinate cloud computing accounts are to be subordinate to the root cloud computing account; and
the cloud service in the subordinate cloud computing account initiates an orchestration function in the root cloud computing account that manages creation of the plurality of subordinate cloud computing accounts.

12. The system of claim 11, the system further comprising the cloud computing platform.

13. The system for performing account creation on a cloud computing platform of claim 11, wherein the orchestration function is configured to initiate creation of a first subordinate cloud computing account of the plurality of subordinate cloud computing accounts.

14. The system for performing account creation on a cloud computing platform of claim 13, further comprising an event rule executed within the root cloud computing account, wherein the event rule is configured to:
monitor an account generation service of the cloud computing platform; and
detect an event indicative of the first subordinate cloud computing account having been created.

15. The system for performing account creation on a cloud computing platform of claim 14, wherein the event rule is further configured to:
in response to detecting the event indicative of the first subordinate cloud computing account having been created, trigger the function to initiate creation of a second subordinate cloud computing account of the plurality of subordinate cloud computing accounts from the request.

16. The system for performing account creation on a cloud computing platform of claim 15, wherein the orchestration function is further configured to:
in response to detecting the event indicative of the first subordinate cloud computing account having been created, cause a notification to be transmitted to a user mapped to the request.

17. The system for performing account creation on a cloud computing platform of claim 11, wherein the cloud service is further configured to:
receive access credentials to the subordinate cloud computing account, wherein the access credentials to the subordinate cloud computing account differ from access credentials for the root cloud computing account.

18. The system for performing account creation on a cloud computing platform of claim 11, wherein the cloud service is further configured to:
based on the request for creation of the plurality of subordinate cloud computing accounts on the cloud computing platform, modify a database stored in the subordinate cloud computing account to indicate each of the plurality of subordinate cloud computing accounts of the request.

19. The system for performing account creation on a cloud computing platform of claim 18, wherein the cloud service is further configured to:
based on the request for creation of the plurality of subordinate cloud computing accounts on the cloud computing platform, validate a name of each of the plurality of subordinate cloud computing accounts of the request.

20. A non-transitory processor-readable medium comprising processor-readable instructions configured to cause one or more processors to:
define, in a subordinate cloud computing account on the cloud computing platform, a request for creation of a plurality of subordinate cloud computing accounts on the cloud computing platform;
access, in the subordinate cloud computing account, a root cloud computing account using access credentials, wherein each of the plurality of subordinate cloud computing accounts are to be subordinate to the root cloud computing account; and
initiate a function in the root cloud computing account that manages creation of the plurality of subordinate cloud computing accounts.
